(19) United States
(12) Patent Application Publication
(10) Pub. No.: US 2026/0159358 A1
(43) Pub. Date: Jun. 11, 2026

(54) METHOD FOR INSTALLING AN ELEVATOR INSTALLATION

(71) Applicant: Inventio AG, Hergiswil (CH)

(72) Inventor: Daniel Zindel, Kussnacht am Rigi (CH)

(21) Appl. No.: 18/722,625

(22) PCT Filed: Dec. 12, 2022
(86) PCT No.: PCT/EP2022/085279

§ 371 Date: Jun. 21, 2024

(30) Foreign Application Priority Data
Dec. 28, 2021 (EP) 21217906.3

(51) Int. Cl. B66B 13/30; B66B 9/00

(52) U.S. Cl. CPC B66B 13/301; B66B 9/00

(57) ABSTRACT

A method for installing an elevator installation includes the following steps: providing elevator components for the elevator installation; packing and transporting at least some of the elevator components in a packaging made from flat material; unpacking the elevator components from the packaging and using the elevator components at the installation location for creating the elevator installation; and using at least part of the packaging in the elevator installation as a skirt by integration into an elevator shaft of the elevator installation. The elevator installation thus incorporates flat material that was used in a first phase as packaging for transporting elevator components for the elevator installation and which was integrated into the elevator shaft in a second phase, such that the flat material is an integral component of the finished elevator installation by forming the skirt.

### FIELD

The present invention relates to a method for installing an elevator installation. Furthermore, the invention relates to an elevator installation.

### BACKGROUND

Elevator installations for conveying people and goods contain elevator cars that can be moved up and down in an elevator shaft. Furthermore, landing doors are provided in the elevator installations on the floors to close the elevator shaft. As a rule, landing door skirts are arranged in the elevator shaft and are attached in the area of the door sills of the landing doors. Such landing door skirts are often prescribed by elevator guidelines or regulations. A landing door skirt according to the prior art is shown in FIG. 2. The landing door skirt is made of sheet steel, making it correspondingly heavy. A further disadvantage is that the familiar landing door skirts are relatively expensive to purchase and sometimes no longer meet high requirements from an ecological point of view. With regard to the installation of the elevator installation, it is necessary for elevator components and parts to be manufactured, packaged, and transported to the installation site.

### SUMMARY

An object of the present invention is therefore that of overcoming the disadvantages of what is familiar, and in particular to create an improved method for installing an elevator installation. The elevator installation created in this way should also meet growing requirements in terms of ecology and conservation of resources.

This object and other objects are achieved according to the invention by the method that has the features described herein. The method for installing the elevator installation comprises the following steps: providing elevator components, such as car doors or landing doors or parts thereof, for the elevator installation, packing and transporting at least some of the elevator components in a packaging preferably made from flat material, unpacking the elevator components from the packaging and using the elevator components at the installation location for creating the elevator installation, and using at least part of the packaging in the elevator installation as an elevator part by integration into the elevator car and/or into the elevator shaft. By integrating at least part of the packaging into the elevator installation, the packaging can be advantageously reused or recycled. Instead of the packaging being disposed of, it is used in the elevator installation.

In a first embodiment, the packaging can, for example, be a folding box made of cardboard, corrugated cardboard, or another flat material, wherein the packaging forms or predetermines an elevator component predetermined by predetermined tear lines and/or fold lines. Thanks to the predetermined tear lines, the elevator component can be easily separated from the packaging.

It can be advantageous if laminated or plasticized cardboard boxes or flat materials provided with waterproof coatings are used to transport the elevator components, which materials result, in the second phase, in durable skirts thanks to their high weather resistance.

The elevator component can particularly preferably be a skirt that is fitted as toe protection in the region of the door sill of a landing door in the elevator shaft. This skirt, also known as a landing door skirt, can be formed simply by or by means of the aforementioned flat material and fastened in the elevator shaft using screws or other fasteners, for example.

A further aspect of the invention relates to an elevator installation or a kit for an elevator installation. The elevator installation contains an elevator shaft and an elevator car that can be moved up and down in the elevator shaft. The elevator installation or the kit for the elevator installation comprises flat material which, in a first phase, can be used or has been used as packaging for transporting elevator components, such as car doors or landing doors for the elevator installation, and which, in a second phase, can be installed or is installed in the elevator shaft and/or in the elevator car, so that the flat material for forming an elevator component is an integral part of the completed elevator installation. By integrating at least part of the packaging into the elevator installation, the packaging can be advantageously reused or recycled. This results in a resource-saving and therefore ecological construction method for the elevator installation. Another advantage is that costs can be saved.

The elevator component can be created by separating it from the packaging and/or by folding it. Additional steps may possibly also be necessary, such as drilling the flat material to create holes for receiving screws for fastening.

Preferably, the packaging can be designed with predetermined tear lines in such a way that the elevator component can be separated from the packaging particularly easily and with few hand movements. No additional tools need to be used to separate the elevator component from the packaging. However, it is conceivable—especially if thick or strong packaging materials are used—to use tools such as knives or jigsaws or the like as an alternative or in addition.

The elevator installation can have landing doors in the elevator shaft. In the region of a door sill of at least one landing door, a skirt can be provided as an elevator component, which is formed from the aforementioned flat material. The elevator component does not necessarily have to be formed entirely from the flat material. Of course, it is conceivable to also provide, in addition to the flat material, means for reinforcing and/or stabilizing the elevator component (e.g., the skirt) in order to form a support structure. Fastening means for fastening the skirt to the shaft wall can also be provided. The flat material, which becomes an integral part of the finished elevator installation, can, instead of the skirt, also be used for another elevator component. An elevator component that is at least in part made of or comprises the flat material can be the car skirt, for example. However, other elevator components, such as wall panels of the elevator car, could also be formed by the flat material.

For a stable skirt, it can be advantageous if the skirt is formed from at least two layers of the flat material, wherein the at least two layers are created by folding the flat material. The respective layers can be connected to each other via a fold line.

It can be particularly advantageous if the skirt is formed from a preferably single blank of the flat material. The blank can be the packaging part separated from the packaging. The outer contour of the blank can therefore be predetermined by the target tear lines on the packaging. The blank can also have fold lines and, if necessary, further predetermined tear lines for specifying cut-outs.

### DESCRIPTION OF THE DRAWINGS

Further individual features and advantages of the invention arise from the following description of an exemplary embodiment and from the drawings. In the drawings:

FIG. 1 is a simplified illustration of an elevator installation in a side view,

FIG. 2 is a perspectival view of a landing door and a landing door skirt according to the prior art,

FIG. 3 is a perspectival view of a landing door having a landing door skirt created using a packaging for transporting elevator components,

FIG. 4 is a plan view of a packaging having a blank for a landing door skirt, and

FIG. 5 is a side view of the landing door skirt produced from the blank according to FIG. 4.

### DETAILED DESCRIPTION

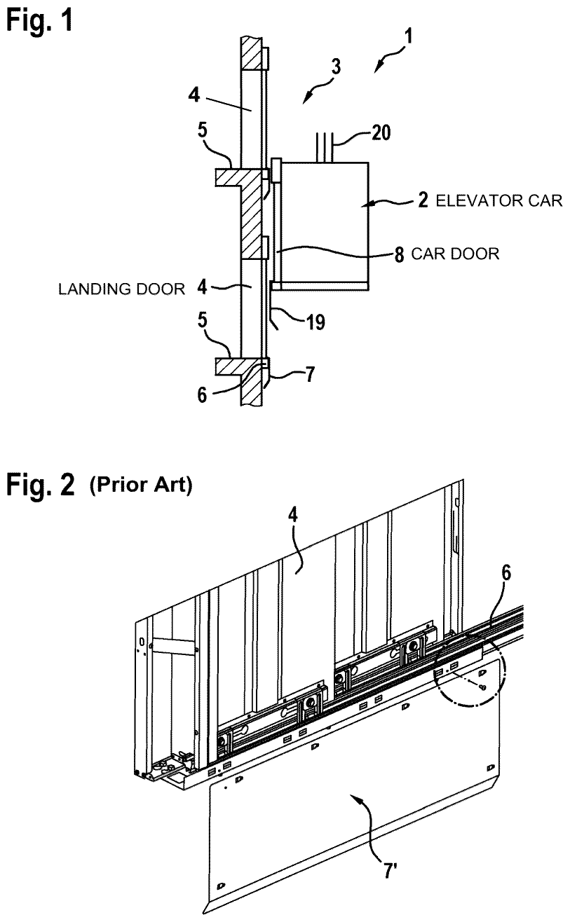

FIG. 1 shows an elevator installation, denoted by 1, for a multi-story building. The building has an elevator shaft 3 in which an elevator car 2 can be moved up and down for transporting people or goods. A landing door 4 is associated with each floor 5. The elevator installation 1 can further comprise a counterweight (not shown) that is connected to the elevator car 2 via suspension means 20 (e.g., belts or steel cables). Furthermore, a drive unit (also not shown) can be provided to move the elevator car 2 and the counterweight. This drive unit (e.g., a traction sheave drive) drives the one or more suspension means 20 and thus moves the car 2 and the counterweight in opposite directions.

The landing door 4 is designed as a landing door of the elevator installation 1 and closes the elevator shaft 3. The landing door 4 thus forms the access from the floor 5 to the elevator installation 1. The elevator car 2 has a car door 8, which interacts with the landing door 4 during a car stop and can be opened and closed simultaneously therewith. Skirts are provided in the region of the respective door thresholds for protection of people. The skirt, which serves as toe protection in the region of the door sill 6 of the landing door 4, is labeled 7. The car skirt 19 is attached to the elevator car 2.

A conventional landing door skirt denoted by 7′ can be seen in FIG. 2. The landing door skirt 7′ consists of a steel sheet that is cut to size and folded. This comparatively heavy sheet steel part is attached to the elevator shaft 3 by means of screws underneath the door sill 6.

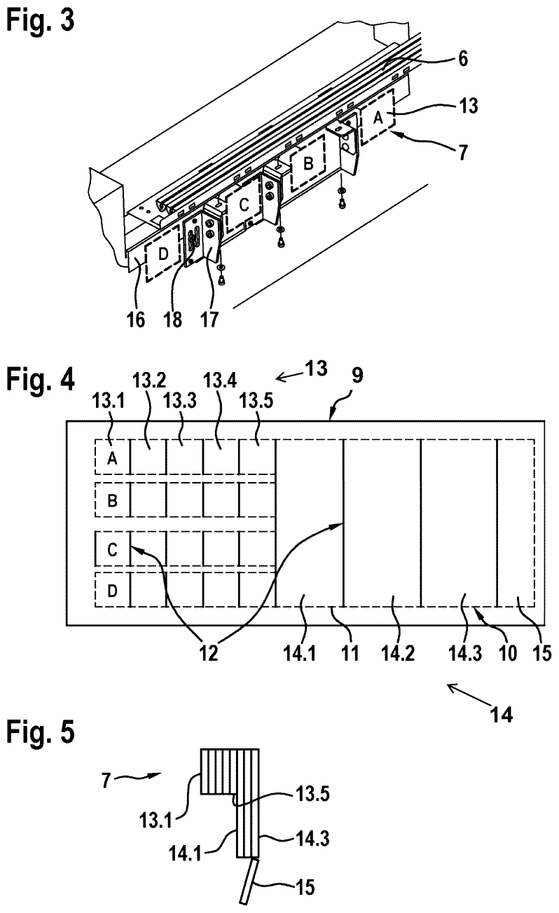

FIG. 3 shows the lower part of a landing door opening having a new type of landing door skirt 7 arranged thereon. In this case, regions marked A-D of the landing door skirt 7 are visible. The remaining regions or parts of the landing door skirt 7 are not shown in FIG. 3 for the sake of simplicity. However, reference is made in the following to FIG. 4, in which the aforementioned regions A-D can again be seen.

FIG. 4 is a plan view of a packaging for elevator components, denoted by 9. For example, elevator doors (such as landing doors or car doors) can be packed and transported in such packaging 9. The packaging 9 consists of a flat material, such as cardboard. The packaging 9 has predetermined tear lines 11, which are indicated by dashed lines, and predetermined fold lines 12, which are indicated by solid lines. The predetermined tear lines 11 and fold lines 12 specify wall portions for the skirt 7 mentioned above. The wall portions labeled 13.1 to 13.5 form fastening portions 13. The fastening portions 13 are segmented, wherein the individual segments are labeled A-D. These regions A-D are fitted in the positions according to FIG. 3. The portions labeled 14.1 to 14.3 form wall portions 14 that define the toe protection region. Finally, 15 denotes an end portion that adjoins the wall portion 14.3 at the end and is preferably angled by 30° in the direction of the shaft wall (cf. FIG. 5).

After the blank 10 has been separated from the packaging 9, the blank is folded like an accordion. The fold lines 12 can be defined by perforation lines or rolled lines, for example. After folding, the structure shown in FIG. 5 results. As can be seen from FIG. 5, the skirt 7 has a multi-layer structure.

There are empty spaces between the individual segments of the fastening portions 13, which spaces are useful for fastening. The three retaining parts 17 shown in FIG. 3 are fitted over these empty spaces. The retaining parts 17 are fastened to a connecting profile 16, which profile is arranged below the door sill 6, by means of screws 18. Once installation is complete, the skirt 7 is clamped in a sandwiched manner between the connecting profile 16 and the individual retaining parts 17.

In order to secure the position of the portion 15 angled by 30°, additional angle pieces (not shown), which are also made of cardboard or are plastic parts, can be glued to the wall portion 14 and the adjoining end portion 15 for stabilization. The angled parts can also be predetermined by the packaging and could be easily separated from the packaging using predetermined tear lines.

Summarized briefly, the method for installing the elevator installation 1 comprises the following steps: first, packagings 9 are provided, in which elevator components are packed. Once the elevator components have been transported, they are removed from the packaging again. However, the remaining packaging 9 is not thrown away, but, rather, put to a second use. For this purpose, the blank 10, which in this example is defined by predetermined tear lines 11 in the packaging, is removed from the packaging, and the separated blank is folded.

In accordance with the provisions of the patent statutes, the present invention has been described in what is considered to represent its preferred embodiment. However, it should be noted that the invention can be practiced otherwise than as specifically illustrated and described without departing from its spirit or scope.

1-8. (canceled)

9. A method for installing an elevator installation, the method comprising the steps of:
providing elevator components for the elevator installation;
packing the elevator components in a packaging made from flat material and transporting the packaged elevator components to an installation location for the elevator installation;
unpacking the elevator components from the packaging at the installation location and using the elevator components to create the elevator installation; and
using at least part of the packaging in the elevator installation as another elevator component by integration into an elevator car of the elevator installation and/or into an elevator shaft of the elevator installation.

10. The method according to claim 9 wherein the flat material is cardboard and including forming predetermined tear lines and/or predetermined fold lines in the cardboard, the lines specifying portions of the another elevator component.

11. The method according to claim 9 wherein the another elevator component is a skirt that is adapted to be fitted as toe protection in a region of a door sill of a landing door in the elevator shaft.

12. An elevator installation comprising:
an elevator shaft;
an elevator car moveable up and down in the elevator shaft; and
a flat material that in a first phase is adapted to package elevator components for transporting to an installation location to enable creation of the elevator installation and in a second phase is adapted to be installed in the elevator shaft and/or on the elevator car such that the flat material forms another elevator component as an integral part of the elevator installation.

13. The elevator installation according to claim 12 wherein the flat material has predetermined tear lines formed therein that enable the another elevator component to be separated from a remainder of the flat material.

14. The elevator installation according to claim 12 including shaft doors in the elevator shaft, at least one of the shaft doors having a door sill, and wherein the another elevator component forms a skirt arranged at the door sill.

15. The elevator installation according to claim 14 wherein the skirt is formed from at least two layers of the flat material formed by folding the flat material.

16. The elevator installation according to claim 14 wherein the skirt is formed from a preferably single blank of the flat material.
